(19) United States
(12) Patent Application Publication
(10) Pub. No.: US 2008/0121671 A1
(43) Pub. Date: May 29, 2008

(54) OVER-CENTER LOCKING LEVER AND STANCHION

(76) Inventors: Robert G. Cronce, Port Huron, MI (US); Terry L. Obermesik, Marysville, MI (US); David W. Gabbard, Marine City, MI (US); John H. Harberts, Macomb, MI (US); John E. Klinkman, Riley Township, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/940,102

(22) Filed: Nov. 14, 2007

Related U.S. Application Data
(60) Provisional application No. 60/858,981, filed on Nov. 14, 2006.

(51) Int. Cl. B60R 9/058

(52) U.S. Cl. 224/331; 224/315; 269/77

(57) ABSTRACT

A stanchion lock mechanism assembly is provided, including a clamp, and pin and a lever. The pin includes a first end and a second end, where the second end of the pin is engaged with the clamp. The lever is rotatable about the first end of the pin and includes a locked position and an unlocked position. The lever is selectively rotatable about an axis that is generally aligned with the pin when in the unlocked position. The lever rotates the pin about the axis, thereby advancing the pin and the clamp in a longitudinal direction with respect to the pin. The lever is rotated no more than one-hundred and eighty degrees about the axis between a first position and a second position, wherein the lever may be placed into the locked position.

### CROSS REFERENCE TO RELATED APPLICATIONS

This application claims priority to U.S. Provisional Patent Application 60/858,981, filed Nov. 14, 2006, which is incorporated by reference in its entirety.

### TECHNICAL FIELD

The present disclosure relates generally to article carrier systems and, more particularly, to a stanchion lock mechanism assembly including a rotatable lever.

### BACKGROUND

Article carrier systems are well known throughout the automotive industry for use in storing or retaining luggage, bicycles, small boats, or the like on the exterior of a motor vehicle. Typically, two cross-rails that are generally parallel to one another and extend between the front and the rear of the vehicle are provided. At least one side rail is positioned between and secured to the two cross-rails by a support. In one type of article carrier system, the support is a cam-based locking mechanism.

The cam-based locking mechanism includes a clamp and a stanchion that each receive the side rail. The clamp is adjusted upwardly or downwardly in the longitudinal direction relative to the stanchion to position the side rail in place. The clamp is adjusted longitudinally by way of a rotatable lever and a pin. The lever is in engagement with the pin such that when the lever is rotated, the pin correspondingly rotates with the lever as well. The pin is connected to the clamp, and moves the clamp upwardly or downwardly when rotated by the lever.

Cam-based locking mechanisms typically lack the precision necessary to lock and unlock the clamp effectively. More specifically, cam-based mechanisms may result in coarse adjustments to the clamp that are especially inconvenient where the rack system employs a marginally tight clamping mechanism that only needs to be adjusted by a few tenths of a millimeter to loosen or tighten the clamping mechanism. Further, improper tightening of the clamp may result in the locking mechanism being slightly loose.

Thus, there exists a need for a cam-based locking mechanism that allows for more accurate adjustments of a clamping mechanism.

### BRIEF DESCRIPTION OF THE DRAWINGS

FIG. 1 is an elevated perspective view of the top of a motor vehicle with an article carrier system including a pair of side rails and a pair of cross rails that have a locking mechanism disposed on each end;

FIG. 2 is an enlarged view of Region 2 in FIG. 1;

FIG. 3 is a partial cross sectional view of the locking mechanism in FIG. 2 in a fully clamped position;

FIG. 4 is a partial cross sectional view of the locking mechanism in FIG. 2 in a partially unclamped position;

FIG. 5 is a partial cross sectional view of the locking mechanism in FIG. 2 in a fully lowered position;

FIG. 6 is an elevational perspective view of an alternative illustration of the locking mechanism;

FIG. 7A is a partial cross sectional view of an alternative locking mechanism having an asymmetrical lever;

FIG. 7B is an enlarged view of the lever shown in FIG. 7A; and

FIG. 8 is a process flow diagram of a method of locking a stanchion lock assembly.

### DETAILED DESCRIPTION

Referring now to the discussion that follows and also to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive or otherwise limit or restrict the claims to the precise forms and configurations shown in the drawings and disclosed in the following detailed description.

According to various exemplary illustrations described herein, a stanchion lock mechanism assembly is provided that includes a clamp, a pin and a lever. The pin includes a first end and a second end, where the second end of the pin is engaged with the clamp. The lever includes a first locked position, a second locked position and an unlocked position and is connected to the first end of the pin. The lever is selectively rotatable about an axis that is generally aligned with the pin when in the unlocked position, where the pin advances the clamp in a longitudinal direction when rotated. The lever is rotated no more than one-hundred and eighty degrees about the axis between the first locked position and the second locked position.

In another exemplary illustration, a stanchion lock mechanism assembly includes a clamp, pin, and lever. The lever includes multiple camming surfaces that are each offset from a center of rotation of the lever by a different distance. Accordingly, the lever may be rotated to align a desired one of the camming surfaces for placing into a locked position, wherein the desired camming surface engages a cavity of the stanchion and advances the clamp a desired distance. Further, each of the various camming surfaces provide a different clamp advancement, allowing increased fine tuning of the clamp mechanism.

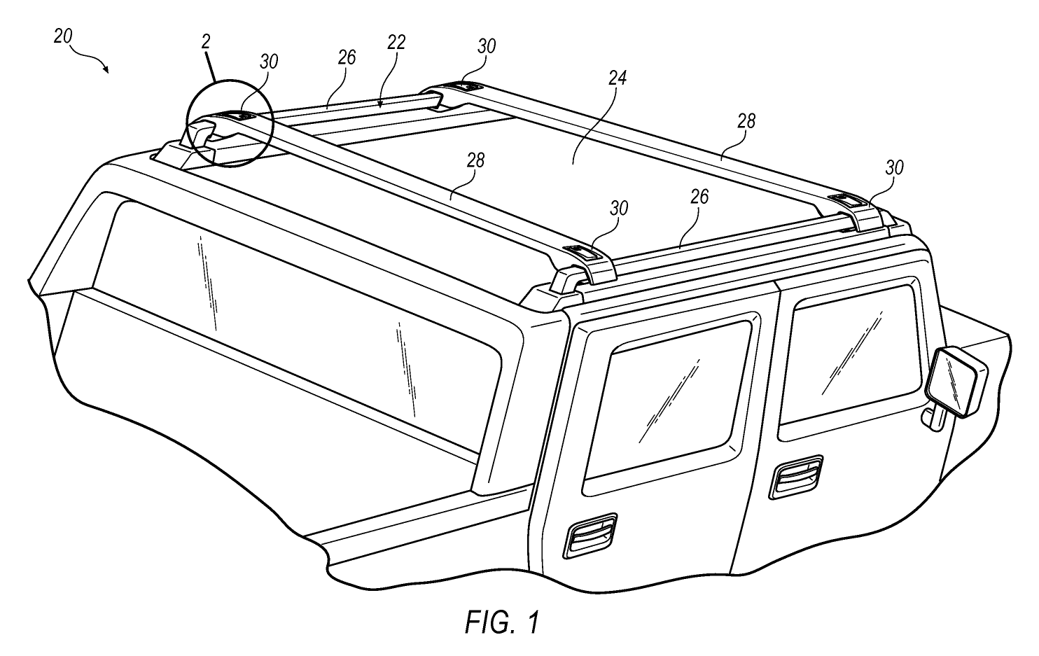

Turning now to the drawings and in particular to FIG. 1, a motor vehicle 20 is illustrated in FIG. 1 having an article carrier system 22 secured to a roof 24 of the vehicle 20. The article carrier system 22 includes a pair of cross rails 28 extending generally across vehicle 20, each cross rail 28 being disposed between two side rails 26 that extend longitudinally along the vehicle. The article carrier system 22 further includes locking mechanisms 30. Four of the locking mechanisms 30 are positioned on cross rails 28, where two locking mechanisms 30 are illustrated on each of the ends of the cross rails 28. The locking mechanisms 30 are employed to position and secure the cross rails 28 to the side rails 26. Although FIG. 1 illustrates the article carrier system 22 located and secured to the roof 24 of the vehicle 20, it should be noted that the article carrier system 22 may be located and secured to any substantially planar surface of the vehicle 20, such as, but not limited to, a bed of a pickup truck or a deck lid of a trunk.

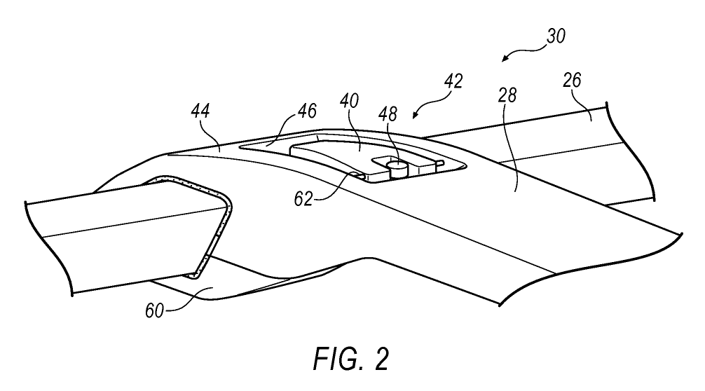

FIG. 2 illustrates one of the locking mechanisms 30. The locking mechanism 30 includes a rotatable lever 40, a stanchion 42, an upper stanchion portion 44, a cavity 46, a pin 48 and a clamp 60. In the illustration as shown, the lever 40 is in a locked position. More specifically, the lever 40 includes a first position and a second position wherein the lever 40 may be placed into the locked position, and is discussed in greater detail below. FIG. 2 illustrates the lever 40 in as it appears after being rotated about pin 48 to either the first position or the second position, and then rotated about rod 62 to the locked position.

The lever 40 is selectively received by the cavity 46, and is in the locked position when received by the cavity 46. The lever 40 is rotatably connected to the pin 48 by way of a rod 62 that passes through a corresponding aperture of the pin 48 (not shown). When the lever 40 is the locked positions, the clamp 60 is unable to move relative to the stanchion 42, and the cross rail 28 is secured to the side rail 26 by the clamp 60 and the upper stanchion portion 44. In one illustration, at least one of the stanchion 42, the lever 40 and the clamp 60 are constructed from a polymer material. However, the stanchion 42, the lever 40 and the clamp 60 may be constructed from metal as well. The pin 48 can also be constructed from a polymer or metal.

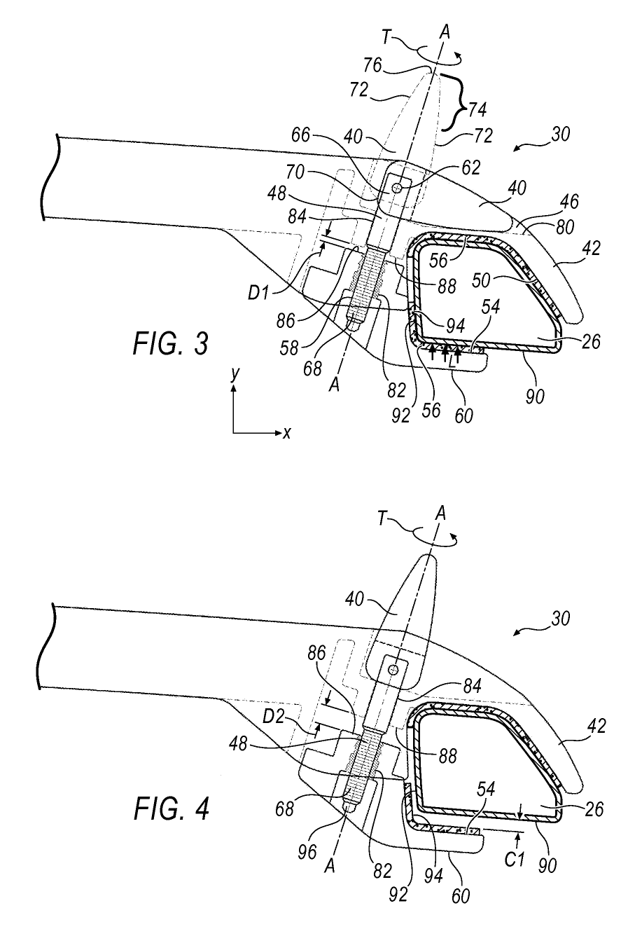

FIG. 3 is a partial cross sectional view of the locking mechanism 30 in the first locked position, with the lever 40 shown in phantom line in an unlocked position. The locking mechanism 30 is illustrated in a fully clamped position. That is, the cross rail 28 secures to side rail 26 by generally clamping side rail 28 with a bottom surface 50 of the stanchion 42 and an upper surface 54 of the clamp 60. Both of the bottom surface 50 of the stanchion 42 and the upper surface 54 of the clamp 60 are configured for receiving the side rail 26. FIG. 3 illustrates the bottom surface 50 and the upper surface 54 lined with a frictional material 56, such as, but not limited to, a felt or a flocking material.

The lever 40 is rotatable in two different directions. First, the lever 40 is rotatable about the rod 62 between the locked position and the unlocked position (shown in phantom line). More specifically, the lever 40 is rotatable in a first direction that is perpendicular to an axis A-A. The axis A-A is generally aligned with the pin 48. In the illustration of FIG. 3, the axis A-A is parallel with the pin 48. When the lever is received by the cavity 46, the lever 40 is in the locked position. The lever 40 may be placed in the unlocked position when rotated about the rod 62 and positioned generally parallel with the axis A-A. The lever 40 is rotatable between the first position and the second position in the second direction, i.e., about the axis A-A.

The lever 40 rotates about axis A-A when a user selectively applies a rotational force T to the lever 40. When a user rotates the lever 40 about the axis A-A, the pin 48 also rotates about the axis A-A as well. More specifically, the pin 48 includes a first end 66 and a second end 68. The first end 66 of the pin 48 is connected to the lever 40, and the second end 68 of the pin 48 is engaged the clamp 60. Because the lever 40 is connected to the pin 48 at the first end 66 by way of the rod 62, the lever 40 and the pin 48 rotate together about the axis A-A. For example, if the lever 40 is rotated one-hundred and eighty degrees (180°) about the axis A-A, the pin 48 is also rotated approximately one-hundred and eighty degrees (180°) as well.

In the illustration as shown, the lever 40 includes a generally planar base outer surface 70 and at least two generally arcuate side surfaces 72. The arcuate side surfaces 72 converge at an angle to form a hand tab portion 74, and terminate at an end surface 76. The hand tab portion 74 of the lever 40 provides a user with an outer surface that is easy to grasp. The hand tab portion 74 also facilitates manipulation of the lever 40 as well by a user. The two side surfaces 72 generally correspond to an arcuate surface 80 of the cavity 46. Therefore, when the lever 40 is received by the cavity 46, the lever 40 is unable to rotate inside the cavity 46, and thus the lever 40 is in one of the locked positions. It should be noted that while FIG. 3 illustrates the lever 40 having only two side surfaces 72, any number of side surfaces 72 that correspond to the arcuate surface 80 of the cavity 46 may be used as well.

In the exemplary illustration of FIG. 3, the lever 40 includes at least two side surfaces 72 that generally oppose each other. Thus, the lever 40 is rotated one-hundred and eighty degrees (180°) about the axis A-A and can then be received by the cavity 46. That is, because the lever 40 includes two side surfaces 72 that correspond with the arcuate surface 80 of the cavity 46, the lever 40 can be placed in the cavity 46 when rotated every one-hundred and eighty degrees (180°) about the axis A-A.

The lever 40 is rotated in the unlocked position one-hundred and eighty degrees (180°) about the axis A-A between the first position and the second position. More specifically, the lever 40 is rotated in the unlocked position from the first position (where the lever 40 is aligned such that placing it in the locked position therefrom will engage one of the side surfaces 72 with the arcuate surface 80 of the cavity) to the second position (where the lever 40 is aligned such that placing it in the locked position therefrom will engage the other of the side surfaces 72 with the arcuate surface 80 of the cavity).

The pin 48 includes a series of threads 58 and is threadingly engaged with a clamp aperture 82 of the clamp 60 when the locking mechanism 30 is in the first locked position as illustrated in FIG. 3. As seen in FIG. 4, as the lever 40 is rotated about the axis A-A into the unlocked position, the pin 48 advances into the stanchion aperture 84 located inside the stanchion 42 and into the corresponding clamp aperture 82. As the pin 48 advances inside the stanchion aperture 84, the clamp 60 is lowered in the longitudinal direction, thereby releasing the cross rail 28 from the side rail 26.

In one illustrative example, a full three-hundred and sixty degrees (360°) rotation of the lever 40 results in a longitudinal movement of the pin 48 being advanced in or out of the clamp aperture 82 and the stanchion aperture 84 by one millimeter (1.0 mm or 0.04 inches). Therefore, allowing the lever 40 to rotate only one-hundred and eighty degrees (180°) will allow for the locking mechanism 30 to provide a more precise adjustment of the clamp 60, because the pin 48 can be advanced in one-half millimeter (0.5 mm) increments instead of the one millimeter (1.0 mm) increment. It should be noted that although FIG. 3 illustrates the pin 48 being advanced in or out of the clamp aperture 82 by a one-hundred and eighty degree (180°) rotation, other dimensions may be used as well, depending on the pitch of the threads 58.

The lever 40 provides greater precision and adjustability of the clamp 60 when compared to traditional levers that can only rotated and locked every three-hundred and sixty degrees (360°). Although FIGS. 1-5 illustrate the lever 40 being able to rotate no more than one-hundred and eighty degrees (180°) between the first locked position and the second locked position, a smaller amount of rotation can be used as well to adjust the lever 40, and is discussed in greater detail below.

FIG. 4 illustrates the clamp 60 in a partially unclamped position, and the lever 40 in the unlocked position. More specifically, when the lever 40 is in the unlocked position, the lever 40 is generally aligned with the axis A-A, and is also generally parallel with the pin 48. The clamp 60 is moved downwardly in the y-direction when the lever 40 is rotated in an unlocking direction about the axis A-A. That is, as the lever 40 is unlocked, the pin 48 moves the clamp 60 upwardly or downwardly depending on the direction of rotation, thus allowing for the cross rail 28 to be removed from or slid along side rail 26. When the clamp 60 is at least partially unclamped, a first clearance C1 is provided between a lower outer surface 90 of the side rail 26 and the upper surface 54 of the clamp 60. The first clearance C1 allows for the cross rail 28 to be moved upwardly or downwardly with respect to side rail 26, and slid along side rail 26 to adjust a position of cross rail 28.

As seen in FIG. 3, the clamp 60 includes a clamp mating surface 86 that is adjacent a stanchion mating surface 88 of the stanchion 42. In the illustration as shown, there is no contact between the clamp mating surface 86 and the stanchion mating surface 88 when the locking mechanism 30 is in one of the locked positions, and includes a first distance D1 between one another. This is because a clamping load L that the clamp 60 exerts is preferably exerted on the lower outer surface 90, as well as an outer side surface 92 of the side rail 26. As the locking mechanism 30 is unlocked, the distance between clamp mating surface 86 and the stanchion mating surface 88 increases, as seen in FIG. 4, and is represented by a second distance D2. It should be noted that while FIGS. 3-4 illustrate the clamp mating surface 86 and the stanchion mating surface 88 including the distances D1 and D2 between one another, the clamp mating surface 86 and the stanchion mating surface 88 may be in contact with each other as well.

As best seen in FIGS. 3-4, the clamp 60 also includes a side surface 94 that is in engagement with the outer side surface 92 of the side rail 26, when in the clamped position. Thus, the side surface 94 and the upper surface 54 of the clamp 60 minimize movement of the cross rail 28 in the side-to-side direction (i.e., laterally across the vehicle) as well as upwardly or downwardly when in the clamped position.

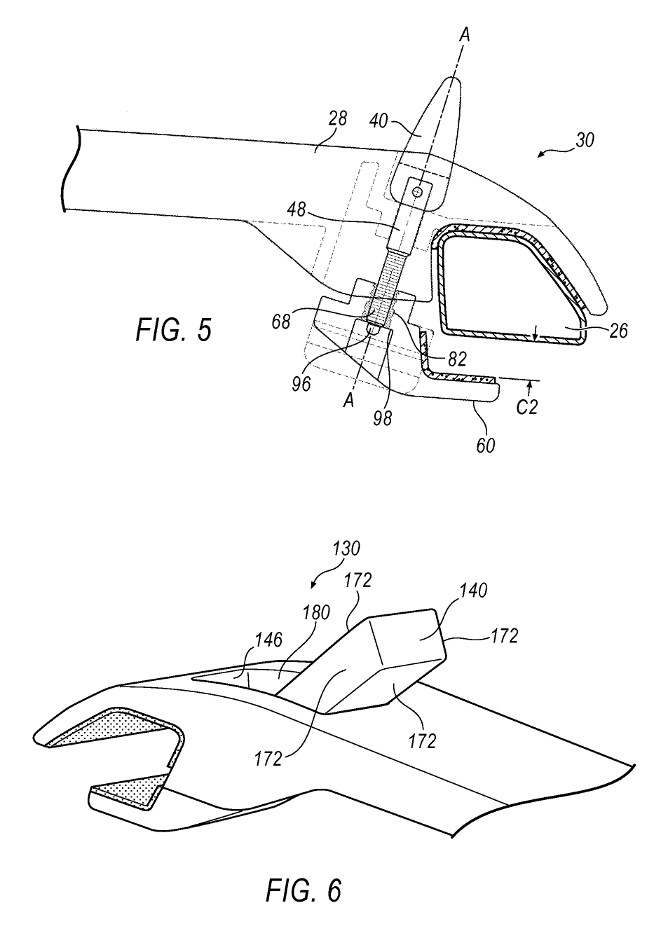

FIG. 5 is an illustration of the clamp 60 in the fully lowered position. When the clamp 60 is in the fully lowered position, the cross rail 28 can be separated from the side rail 26, by way of a second clearance C2. In one example, the second clearance C2 includes a dimension of 12.7 mm (0.5 inches). The clamp 60 is moved in the fully lowered position by threadingly disengaging the pin 48 from the clamp aperture 82. In the illustration as shown, the pin 48 is threadingly disengaged by a stop 96 that is located at the second end 68 of the pin 48. The stop 96 may be any type of fastener that is able to be threaded onto the pin 48, such as, but not limited to, a washer or a screw. In the illustration of FIG. 5, the stop 96 is shown in the maximum loosening position, and rests along a stopper surface 98 of the clamp 60.

FIG. 6 is an alternative illustration of the locking mechanism 130, including a four-sided lever 140. The lever 140 includes four side surfaces 172. Each of the side surfaces 172 correspond with the surface 180 of the cavity 146. In the illustration as shown, the lever 140 is shown in the unlocked position.

The lever 140 can be rotated every ninety degrees (90°) and locked, instead of one-hundred and eighty degrees (180°) in the illustrations of FIGS. 1-5. Therefore, the lever 140 further includes a third position and a fourth position. Because the lever 140 is able to be placed into a locked position every ninety degrees (90°), further fine-tuning of the locking mechanism 130 is achieved. More specifically, in one example, the lever 140 is rotated every ninety degrees (90°) and results in a quarter millimeter (0.25 mm or 0.009 inches) longitudinal adjustment of the clamp 160, instead of the traditional one millimeter (1.0 mm) increment, as discussed above. It is understood that the lever 140 can be constructed to include any number of side surfaces 172 such that the lever 140 can be locked at a variety of positions, such as, but not limited to, a rotation of sixty degrees (60°), ninety degrees (90°), one-hundred and twenty degrees (120°), and one-hundred and eighty degrees (180°).

Lever 40 has been described above as a generally symmetrical lever about the center of rotation, such that each side surfaces provide a generally equal advancement of pin 48 when lever 40 is moved from an unlocked position to a locked position. However, lever 40 may be provided with an asymmetrical profile that allows for different clamp advancements when lever 40 is moved from an unlocked position to a locked position, depending on which side of lever 40 is engaged with the stanchion cavity 46.

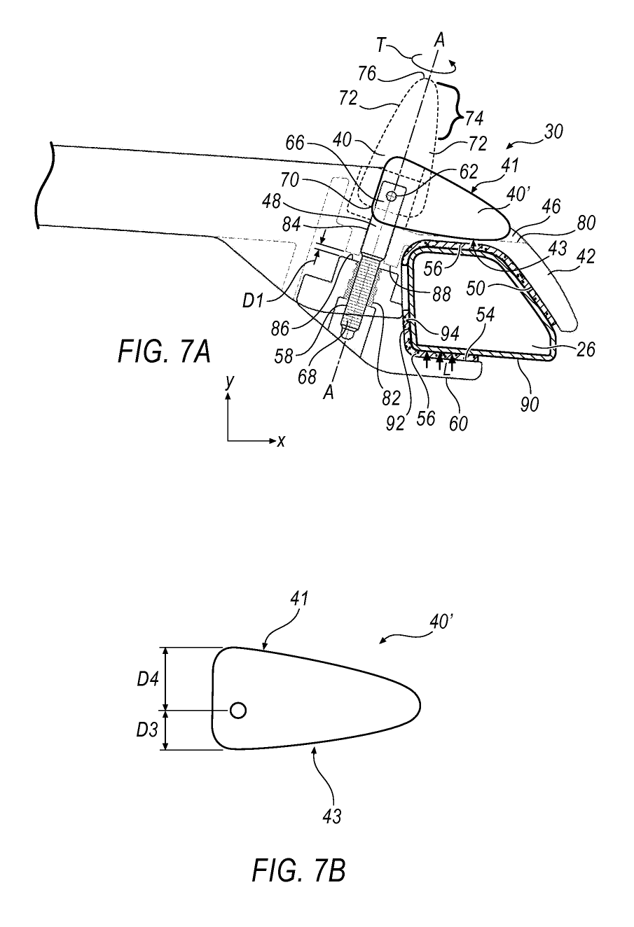

For example, turning now to FIGS. 7A and 7B, an alternative example of a locking mechanism 30 having an asymmetrical lever 40′ is illustrated. Locking mechanism 30 includes a lever 40′ that provides multiple clamp advance adjustments when the lever 40 is rotated from an unlocked position (lever 40′ shown in phantom) to a locked position (lever 40′ shown in solid lines). As best seen in FIG. 7B, lever 40′ has a first camming surface 43 that is offset from a center of rotation of lever 40′ by a distance D3, and a second camming surface 41 that is offset from a center of rotation of lever 40′ by a distance D4. Offset distances D3 and D4 are generally not equal, and thus will advance clamp 60 varying distances or magnitudes depending on which of first and second camming surfaces are engaged with cavity 46 when lever 40′ is placed in the locked position. This feature may provide additional fine adjustments to the advancement of clamp 60, in addition to the ability of rotating lever 40′ 180 degrees or less about pin 48 between the first and second positions for locking lever 40. Further, although lever 40′ has been described as having two camming surfaces 43, 41, more than two camming surfaces may be provided. For example, a four-sided lever (similar to lever 140 illustrated in FIG. 6) may have four camming surfaces, each of which provide a different offset distance, and therefore a different clamp advancement, when the respective camming surface is aligned for engagement with a cavity of a stanchion and placed into a locked position.

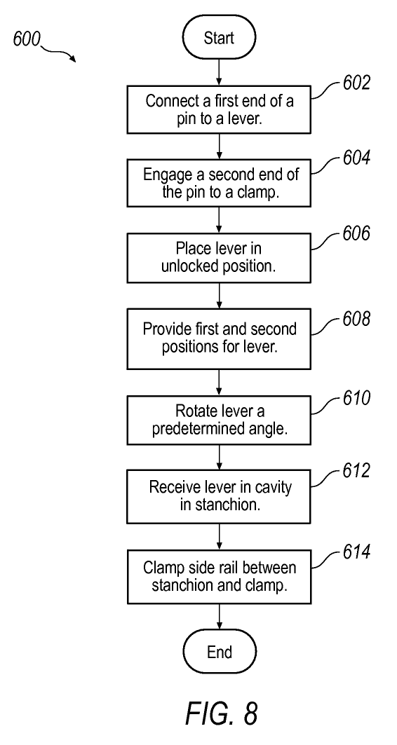

Turning now to FIG. 8, a process 600 for locking a stanchion lock mechanism assembly is illustrated. Process 600 may begin at step 602, where a first end of a pin is connected to a lever. For example, as discussed above, the pin 48 includes a first end 66 that is connected to the lever 40 with rod 62. Process 600 may then proceed to step 604.

In step 604, a second end of the pin is engaged to a clamp. For example, as described above, the pin 48 includes the second end 68 that is engaged with the clamp 60. Process 600 may then proceed to step 606.

In step 606, the lever is placed in an unlocked position, the lever being generally freely rotatable about an axis generally parallel to the pin, and the lever advances the clamp in a longitudinal direction when the lever is rotated about the axis. For example, as described above, lever 40 may be oriented generally upright and/or parallel to axis A-A, the lever being generally freely rotatable about axis A-A. Further, rotation of lever 40 about the first end of the pin 48 may advance the clamp longitudinally, e.g., along the direction of axis A-A. Process 600 may then proceed to step 608.

In step 608, first and second positions are provided for the lever 40, the lever 40 being rotatable about the first end of the pin to a locked position only when the lever 40 is in one of the first and second positions, the lever 40 being generally prevented from being rotated about the axis when the lever 40 is in the locked position. For example, as described above, lever 40 may be selectively rotatable about axis A-A between a first position and a second position that are spaced apart by about 180 degrees. In each of the first and second positions, the lever 40 is capable of being rotated about rod 62 to a locked position, in which the lever 40 is generally prevented from rotating about axis A-A by the engagement of lever 40 with the stanchion. Additionally, as described above, a lever 40′ may be employed that has at least two camming surfaces, each defining a different offset distance from a center of rotation of the lever 40′. Accordingly, lever 40′ may advance clamp 60 different distances, depending on which of first and second camming surfaces 43, 41 are engaged with cavity 46 (i.e., depending on which of the first and second positions, respectively, lever 40′ is placed in prior to moving lever 40′ from the unlocked position to the locked position). Process 600 may then proceed to step 610.

In step 610, the lever is rotated about the axis of the pin between the first and second positions, which are spaced apart rotationally about axis A-A by a predetermined angle. The predetermined angle is no more than 180 degrees, as described above. Process 600 may then proceed to step 612.

In step 612, the lever is received in a cavity that is located at an upper portion of the stanchion. For example, as described above, the lever 40 is received by the cavity 46 that is located in the upper stanchion portion 44. The cavity 46 is configured for selectively receiving the lever 40. Process 600 may then proceed to step 614.

In step 614, the side rail is clamped between a bottom surface of the stanchion and an upper surface of the clamp. For example, as described above, the cross rail 28 is secured to side rail 26 by clamping side rail 26 between the bottom surface 50 of the stanchion 42 and an upper surface 54 of the clamp 60. Both of the bottom surface 50 of the stanchion 42 and the upper surface 54 of the clamp 60 are configured for receiving the side rail 26. Process 600 may then terminate.

While the present disclosure has been particularly shown and described with reference to the foregoing preferred illustrations, it should be understood by those skilled in the art that various alternatives to the illustrations of the disclosure described herein may be employed in practicing the disclosure without departing from the spirit and scope of the disclosure as defined in the following claims. It is intended that the following claims define the scope of the disclosure illustrations within the scope of these claims and their equivalents be covered thereby. This description of the disclosure should be understood to include all novel and non-obvious combinations of elements described herein, and claims may be presented in this or a later application to any novel and non-obvious combination of these elements. The foregoing embodiment is illustrative, and no single feature or element is essential to all possible combinations that may be claimed in this or a later application.

What is claimed is:

1. A stanchion lock mechanism assembly, comprising:
a pin including a first end and a second end;
a clamp that is engaged with the second end of the pin; and
a lever rotatably connected to the first end of the pin, wherein the lever is rotatable about the first end of the pin between a locked position and an unlocked position, the lever being selectively rotatable about an axis generally aligned with the pin between a first position and a second position when the lever is in the unlocked position, the pin advancing the clamp in a longitudinal direction when the lever is rotated about the axis, the lever being capable of being rotated about the first end of the pin from the unlocked position to the locked position only when the lever is in one of the first and second positions;
wherein the lever is rotated about the axis a predetermined angle between the first and second positions, the predetermined angle being no more than one-hundred and eighty degrees.

2. The stanchion lock mechanism assembly as recited in claim 1, wherein the lever includes a first camming surface and a second camming surface, the pin advancing the clamp when the lever is rotated about the first end of the pin from the unlocked to the locked position, the first and second camming surfaces generally disposed on opposite sides of the lever, the first camming surface associated with the first position, the second camming surface associated with the second position.

3. The stanchion lock mechanism assembly as recited in claim 2, wherein the first and second camming surfaces each define a generally same offset between a center of rotation of the lever and each of the first and second camming surfaces, respectively.

4. The stanchion lock mechanism assembly as recited in claim 2, wherein the first camming surface defines a first offset from a center of rotation of the lever, and the second camming surface defines a second offset from the center of rotation of the lever, thereby providing a first clamp advance when the lever is placed in the first position and locked, and a second clamp advance when the lever is placed in the second position and locked, the first and second clamp advances being generally unequal distances.

5. The stanchion lock mechanism assembly as recited in claim 1, wherein an upper portion of the stanchion includes a cavity that is configured for selectively receiving the lever, the lever being in the locked position when received by the cavity.

6. The stanchion lock mechanism assembly as recited in claim 5 wherein the lever includes at least two outer surfaces that correspond with an outer surface of the cavity.

7. The stanchion lock mechanism assembly as recited in claim 5, wherein the lever is selectively rotatable about an axis generally aligned with the pin between a third position and a fourth position, and the lever being capable of being rotated about the first end of the pin from the unlocked position to the locked position only when the lever is in one of the first, second, third, and fourth positions, wherein the first, second, third, and fourth positions are spaced about the axis by about ninety degrees.

8. The stanchion lock mechanism assembly as recited in claim 1, wherein the pin and the lever are connected by way of a rod, and the lever is rotatable about the rod in a direction that is perpendicular to the axis.

9. The stanchion lock mechanism assembly as recited in claim 1, wherein the pin is threadingly engaged with the clamp.

10. The stanchion lock mechanism assembly as recited in claim 1, wherein the pin includes a retaining feature at the second end, the retaining feature being threadingly engaged with the pin, and holding the clamp in place along the pin.

11. The stanchion lock mechanism assembly as recited in claim 1, further comprising a side rail, wherein a bottom surface of the stanchion and an upper surface of the clamp are configured to receive the side rail.

12. The stanchion lock mechanism assembly as recited in claim 11, wherein at least one of the bottom surface of the stanchion and the upper surface of the clamp include a frictional material.

13. A stanchion lock mechanism assembly, comprising:
a pin including a first end and a second end;
a clamp that is engaged with the second end of the pin; and
a lever rotatably connected to the first end of the pin, wherein the lever is rotatable about the first end of the pin between a locked position and an unlocked position, the lever being selectively rotatable about an axis generally aligned with the pin between a first position and a second position when the lever is in the unlocked position;
wherein the lever includes a first camming surface and a second camming surface, the pin advancing the clamp when the lever is rotated about the first end of the pin from the unlocked to the locked position, the first camming surface associated with the first position, the second camming surface associated with the second position.

14. The stanchion lock mechanism assembly as recited in claim 13, wherein the first and second camming surfaces each define a generally same offset between a center of rotation of the lever and each of the first and second camming surfaces, respectively.

15. The stanchion lock mechanism assembly as recited in claim 13, wherein the first camming surface defines a first offset from a center of rotation of the lever, and the second camming surface defines a second offset from the center of rotation of the lever, thereby advancing the clamp a first magnitude when the lever is placed in the first position and locked, and advancing the clamp a second magnitude when the lever is placed in the second position and locked, the first and second magnitudes being generally unequal.

16. The stanchion lock mechanism assembly as recited in claim 13, wherein the first and second camming surfaces are generally disposed on opposite sides of the lever.

17. The stanchion lock mechanism assembly as recited in claim 13, wherein the lever is capable of being rotated about the first end of the pin from the unlocked position to the locked position only when the lever is in one of the first and second positions, and wherein the lever is rotated about the axis a predetermined angle between the first and second positions, the predetermined angle being no more than one-hundred and eighty degrees.

18. The stanchion lock mechanism assembly as recited in claim 14, wherein the first and second camming surfaces each correspond with an outer surface of the cavity for engagement therewith.

19. The stanchion lock mechanism assembly as recited in claim 13, further comprising a side rail, wherein a bottom surface of the stanchion and an upper surface of the clamp are configured to receive the side rail.

20. A method of locking a stanchion lock mechanism assembly, comprising:
connecting a first end of a pin to a lever;
engaging a second end of the pin to a clamp;
placing the lever in an unlocked position, wherein the lever may be generally freely rotated about an axis generally parallel to the pin, wherein the lever advances the clamp in a longitudinal direction when the lever is rotated about the axis;
providing a first position and a second position, wherein the lever is rotatable about the first end of the pin to a locked position only when the lever is in one of the first and second positions, wherein the lever is generally prevented from being rotated about the axis when the lever is in the locked position; and
rotating the lever about the axis a predetermined angle between the first and second positions, the predetermined angle being no more than one-hundred and eighty degrees.

21. The method as recited in claim 16, further comprising providing a lever having first and second camming surfaces, each of said first and second camming surfaces defining a different offset from a center of rotation of the lever, wherein the lever advances the clamp a first magnitude when the lever is placed in the first position and then locked, and the lever advances the clamp a second magnitude when the lever is placed in the second position and then locked, the first and second magnitudes being generally unequal.

22. The method as recited in claim 16, further comprising the step of receiving the lever in a cavity located at an upper portion of the stanchion when the lever is placed in the locked position, the cavity configured for selectively receiving the lever.

23. The method as recited in claim 16, further comprising the step of clamping a side rail between a bottom surface of the stanchion and an upper surface of the clamp.
